(19) United States
(12) Patent Application Publication
(10) Pub. No.: US 2013/0235175 A1
(43) Pub. Date: Sep. 12, 2013

(54) ENDOSCOPE SYSTEM

(71) Applicant: OLYMPUS CORPORATION, Tokyo (JP)

(72) Inventor: Satoshi Kazama, Tokyo (JP)

(73) Assignee: OLYMPUS CORPORATION, Tokyo (JP)

(21) Appl. No.: 13/794,235

(22) Filed: Mar. 11, 2013

(30) Foreign Application Priority Data
Mar. 12, 2012 (JP) 2012-054499

(51) Int. Cl. H04N 7/18

(52) U.S. Cl. CPC H04N 7/18
USPC 348/65

(57) ABSTRACT

Provided is an endoscope system in which an insertion unit includes a distal end, an optical fiber cable configured to transmit a first image signal output by an image signal generating unit as an optical signal, and an electric cable configured to transmit the second image signal output by the image signal generating unit as an electrical signal. An image signal processing unit performs image processing of any one of the first image signal or the second image signal transmitted by the insertion unit. A scope distal end includes an imaging unit configured to include a plurality of pixels to output a pixel signal, and the image signal generating unit configured to generate the first image signal and the second image signal having a data volume smaller than that of the first image signal using the pixel signal output by the imaging unit.

### BACKGROUND OF THE INVENTION

1. Field of the Invention

The present invention relates to an endoscope system.

This application claims priority to and the benefit of Japanese Patent Application No. 2012-054499 filed on Mar. 12, 2012, the disclosure of which is incorporated by reference herein.

2. Description of Related Art

Endoscope systems are being manufactured in which an endoscope scope including an imaging unit at a distal end thereof is inserted into an object to be inspected such as a human body or the like, an image signal is transmitted from the distal end to an endoscope main body, which is disposed at the outside of the object to be inspected, to observe an image in the object to be inspected through a monitor or the like, or treatment is performed by a forceps or the like. In such an endoscope system, an image signal, which is an analog signal output from the imaging unit, is transmitted from the imaging unit to the endoscope main body through an electric cable of several meters. When the analog signal is transmitted through the electric cable, a signal to noise (S/N) ratio or image quality of the image signal may be affected by an exogenous noise of an electric knife or the like.

In consideration of the influence of the exogenous noise, a method of analog/digital signal converting (A/D converting) the image signal output from the imaging unit at the distal end of the endoscope scope and transmitting the converted digital signal through the electric cable is proposed. In addition, in the endoscope system in recent times, in order to achieve high image quality, there are requirements for high resolution of the imaging unit, a high frame rate of the image signal, and high gradation. In addition, in order to reduce a burden on a human body, reduction in external diameter of the endoscope scope inserted into the object to be inspected is needed.

According to the requirement of high resolution, transmission of the increased digital signal through the electric cable is needed. For example, when a transmission limit of the electric cable is 200 Mbps and a transmission rate of the image signal is 200 Mbps, transmission can be performed through one electric cable. However, according to the requirement of high resolution, when transmission of the image signal of 1.2 Gbps is needed, six (=1.2 Gbps/200 Mbps) electric cables are needed.

Here, a method of optically transmitting the image signal from the endoscope scope distal end to the endoscope main body using an optical fiber cable is receiving attention as a technique corresponding to the two requirements of high resolution and reduction in diameter.

As an example thereof, a technique in which a light emitting unit configured to emit the optical signal in a state in which the image signal is converted into the optical signal is disposed at the endoscope scope distal end, a light receiving unit configured to receive the optical signal is disposed at the endoscope main body, and the light emitting unit and the light receiving unit are connected by an optical fiber cable to transmit the image signal as the optical signal is well known (for example, see Japanese Unexamined Patent Application, First Publication No. 2007-260066). According to the description of Japanese Unexamined Patent Application, First Publication No. 2007-260066, even when the transmission rate exceeds 1 Gbps, the image signal can be transmitted through one optical fiber cable.

### SUMMARY OF THE INVENTION

According to a first aspect of the present invention, an endoscope system includes: an insertion unit includes a distal end, an optical transmission line configured to transmit a first image signal output by an image signal generating unit as an optical signal and an electrical transmission line configured to transmit a second image signal output by the image signal generating unit as an electrical signal; and an image signal processing unit configured to perform image processing of any one of the first image signal and the second image signal transmitted by the insertion unit, wherein the distal end of the insertion unit includes an imaging unit configured to output a pixel signal which includes a plurality of pixels, and the image signal generating unit configured to generate the first image signal and the second image signal having a data volume smaller than that of the first image signal by using the pixel signal output by the imaging unit.

In addition, according to a second aspect of the present invention, in the endoscope system according to the first aspect, at least one of temporal resolution, spatial resolution, and gradation resolution of the second image signal may be lower than that of the first image signal.

Further, according to a third aspect of the present invention, in the endoscope system according to the second aspect, the image signal generating unit may generate the second image signal having spatial resolution lower than that of the first image signal using a portion of the pixel signals, among the pixel signals.

Furthermore, according to a fourth aspect of the present invention, in the endoscope system according to the second aspect, the image signal generating unit may generate the first image signal using the pixel signal output by the pixel included in a first region that is an imaging region of the imaging unit, and generate the second image signal using the pixel signal output by the pixel included in a second region that is a region of a portion of the first region.

In addition, according to a fifth aspect of the present invention, in the endoscope system according to the second aspect, the image signal generating unit may generate the second image signal having temporal resolution lower than that of the first image signal by reducing a frame rate of the second image signal to be lower than that of the first image signal.

Further, according to a sixth aspect of the present invention, in the endoscope system according to the first aspect, the image signal generating unit may generate the first image signal or the second image signal.

Furthermore, according to a seventh aspect of the present invention, in the endoscope system according to the first aspect, the endoscope system may further include a detection unit configured to detect whether the optical transmission line functions normally or not, and configured to control to generate the second image signal to the image signal generating unit when the optical transmission line functions abnormally.

In addition, according to an eighth aspect of the present invention, in the endoscope system according to the first aspect, the distal end may further include a mode control unit configured to control to drive the imaging unit, and the mode control unit may change a driving method of the imaging unit when the image signal generating unit generates the first image signal and when the image signal generating unit generates the second image signal.

### BRIEF DESCRIPTION OF THE DRAWINGS

FIG. 1 is a schematic view showing an outer appearance of an endo scope system according to a first embodiment of the present invention;

FIG. 2 is a block diagram showing a configuration of the endo scope system according to the first embodiment of the present invention;

FIG. 3 is a schematic view showing a horizontal synchronization signal and a vertical synchronization signal superimposed on an image signal in the first embodiment of the present invention;

FIG. 4 is a circuit diagram showing a circuit configuration of a switching unit in the first embodiment of the present invention;

FIG. 5 is a circuit diagram showing a circuit configuration of a selection unit in the first embodiment of the present invention;

FIG. 6 is a schematic view showing a pixel signal used when an image signal generating unit generates an image signal without thinning the pixel signal in the first embodiment of the present invention;

FIG. 7 is a schematic view showing an image signal used when the image signal generating unit generates the image signal by thinning the pixel signal in the first embodiment of the present invention;

FIG. 8 is a block diagram showing a configuration of an endoscope system according to a second embodiment of the present invention;

FIG. 9 is a block diagram showing a circuit configuration of a mode-change unit and a mode control unit in the second embodiment of the present invention;

FIG. 10 is a schematic view schematically showing a serial signal converted by a serializer in the second embodiment of the present invention;

FIG. 11 is a schematic view showing a pixel signal used when an image signal generating unit generates an image signal in the second embodiment of the present invention;

FIG. 12 is a schematic view showing a pixel signal used when the image signal generating unit generates an image signal in the second embodiment of the present invention; and

FIG. 13 is a schematic view showing a pixel signal used when an image signal generating unit generates an image signal in a third embodiment of the present invention.

### DETAILED DESCRIPTION OF THE INVENTION

### First Embodiment

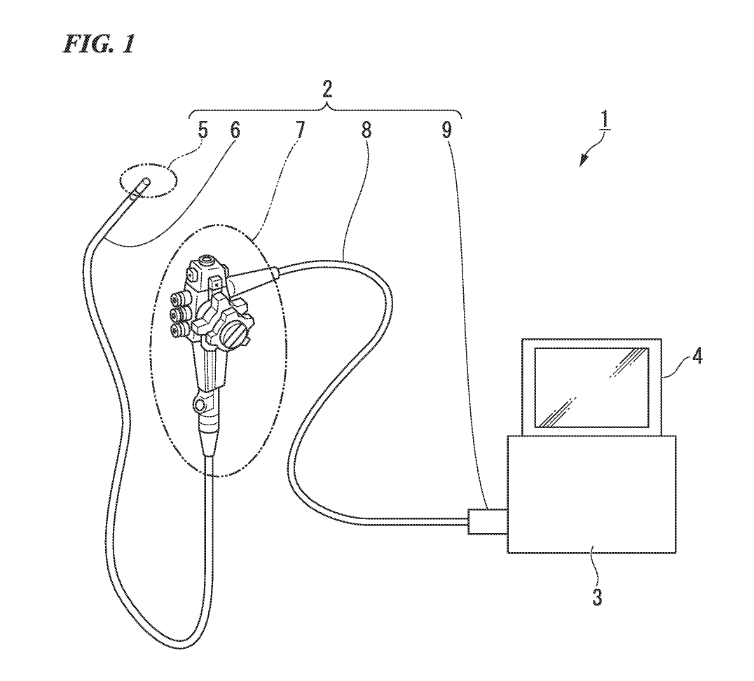

Hereinafter, a first embodiment of the present invention will be described with reference to the accompanying drawings. FIG. 1 is a schematic view showing an outer appearance of an endoscope system of the embodiment. In a shown example, an endoscope system 1 includes an endoscope scope 2, an endoscope main body 3, and a monitor 4. The endoscope scope 2 captures the inside of an object to be inspected to generate an image signal, and transmits the generated image signal to the endoscope main body 3. The endoscope main body 3 processes the image signal transmitted from the endoscope scope 2. The monitor 4 displays the image signal processed by the endoscope main body 3.

The endoscope scope 2 includes a scope distal end 5 (a distal end), an insertion unit 6, a manipulation unit 7, a universal cord 8, and a connector 9. The scope distal end 5 is a part inserted into the object to be inspected, and includes an imaging unit. The insertion unit 6 guides the scope distal end 5 into the object to be inspected. The manipulation unit 7 manipulates movement of bending of the scope distal end 5 via the insertion unit 6. The universal cord 8 connects the manipulation unit 7 and the endoscope main body 3 via the connector 9. The connector 9 detachably connects the universal cord 8 and the endoscope main body 3.

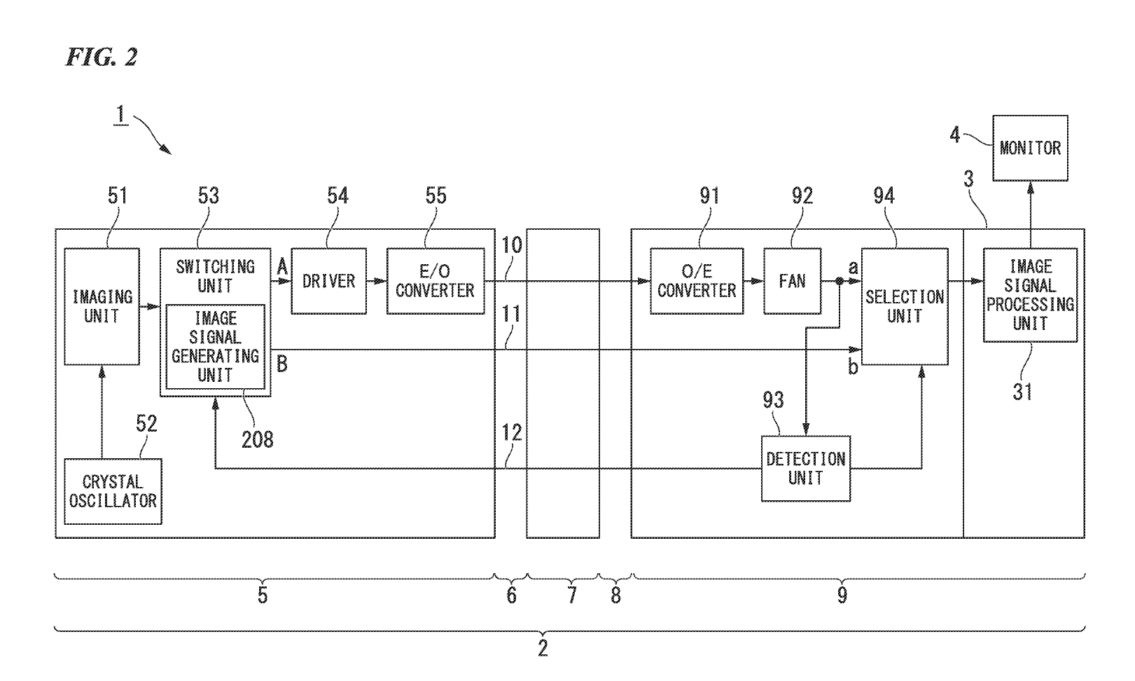

Next, a configuration of the endoscope system 1 will be described. FIG. 2 is a block diagram showing a configuration of the endoscope system 1 in the embodiment. In FIG. 2, in the embodiment, only a part needed to describe image signal transmission is shown. In the shown example, the scope distal end 5 includes an imaging unit 51, a crystal oscillator 52, a switching unit 53, a driver 54, and an electronic/optical signal converter (E/O converter) 55. In addition, the connector 9 includes an optical/electronic signal converter (O/E converter) 91, an amplifier 92, a detection unit 93, and a selection unit 94. The endoscope main body 3 includes an image signal processing unit 31.

In addition, the insertion unit 6, the manipulation unit 7 and the universal cord 8 include an optical fiber cable 10, and electric cables 11 and 12. The optical fiber cable 10 connects the E/O converter 55 of the scope distal end 5 and the O/E converter 91 of the connector 9. Further, the electric cable 11 connects the switching unit 53 of the scope distal end 5 and the selection unit 94 of the connector 9. Furthermore, the electric cable 12 connects the switching unit 53 of the scope distal end 5 and the detection unit 93 of the connector 9.

The imaging unit 51 includes a complementary metal oxide semiconductor (CMOS) sensor having an imaging region constituted by a plurality of pixels. The imaging unit 51 reads and outputs a pixel signal by a pixel unit. The crystal oscillator 52 supplies a reference clock to the imaging unit 51. The switching unit 53 acquires the pixel signal output from the imaging unit 51. In addition, the switching unit 53 includes an image signal generating unit 208. The image signal generating unit 208 receives a detection signal input from the detection unit 93 via the electric cable 12, and generates an image signal using the acquired pixel signal based on the detection signal. Specifically, the image signal generating unit 208 generates an image signal (a first image signal) of the entire imaging region of the imaging unit 51 and an image signal (a second image signal) having a smaller data volume than the first image signal, based on the input detection signal. The switching unit 53 receives the detection signal input from the detection unit 93 via the electric cable 12. The switching unit 53 outputs the image signal generated by the image signal generating unit 208 to the driver 54, or outputs the image signal to the selection unit 94 of the connector 9 via the electric cable 11, based on the detection signal. The switching unit 53 will be described in detail below. A terminal configured to output the image signal to the driver 54 is referred to as an output terminal A, and a terminal configured to output the image signal to the selection unit 94 of the connector section 9 via the electric cable 11 is referred to as an output terminal B.

The driver 54 acquires the image signal output from the output terminal A of the switching unit 53, and outputs the image signal to the E/O converter 55. In addition, the driver 54 drives the E/O converter 55. The E/O converter 55 is a semiconductor laser such as a laser diode (LD), a vertical-cavity surface-emitting laser (VCSEL), or the like. The E/O converter 55 converts the image signal input from the driver 54 into an optical signal, and outputs the optical signal to the optical fiber cable 10.

The O/E converter 91 is a semiconductor photo detector such as a photo diode (PD) or the like. The O/E converter 91 converts the optical signal which is output from the E/O converter 55 and transmitted via the optical fiber cable 10 into an electrical signal, and outputs the electrical signal to the amplifier 92. The electrical signal is the image signal output by the switching unit 53. The amplifier 92 amplifies the image signal output by the O/E converter 91 and performs binarization processing. In addition, the amplifier 92 outputs the image signal obtained by undergoing the binarization processing to the detection unit 93 and the selection unit 94. The detection unit 93 detects whether the optical fiber cable 10 functions normally or not (for example, whether the optical fiber cable 10 is short-circuited or not), based on the image signal input from the amplifier 92. In addition, the detection unit 93 outputs the detection signal, which indicates whether the optical fiber cable 10 functions normally, to the selection unit 94. In addition, the detection unit 93 transmits the detection signal, which informs whether the optical fiber cable 10 functions normally, to the switching unit 53 via the electric cable 12.

The selection unit 94 outputs any one of the image signal input from the amplifier 92 and the image signal input from the switching unit 53 of the scope distal end via the electric cable 11 to the image signal processing unit 31 of the endoscope main body 3, based on the detection signal input from the detection unit 93. A terminal into which the image signal is input from the amplifier 92 is referred to as an input terminal a, and a terminal into which the image signal is input from the switching unit 53 of the scope distal end 5 via the electric cable 11 is referred to as an input terminal b. An image signal processing unit 31 performs various kinds of image processing on the image signal input from the selection unit 94, and displays the image based on the image signal on the monitor 4.

In the embodiment, an optical transmission line is constituted by the E/O converter 55, the optical fiber cable 10, and the O/E converter 91. In addition, an electrical transmission line is constituted by the electric cable 11. Further, a pixel signal output from the imaging unit 51 is a digital signal. The digital signal is output as the image signal at the switching unit 53, and transmitted to the image signal processing unit 31 via the optical transmission line or the electrical transmission line.

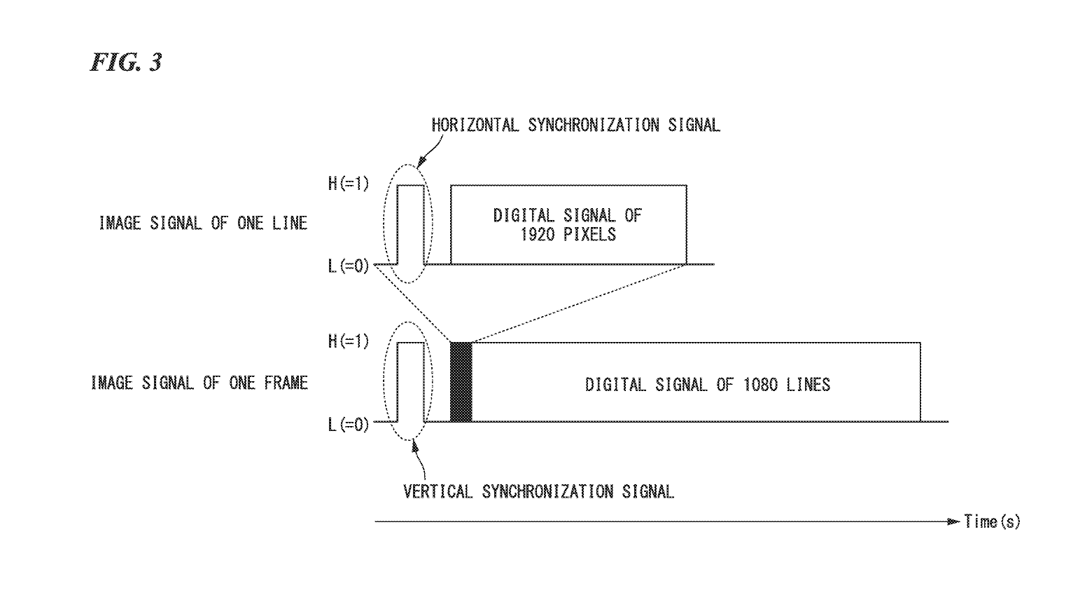

Next, the image signal transmitted to the connector 9 from the scope distal end 5 via the optical fiber cable 10 will be described. FIG. 3 is a schematic view showing a horizontal synchronization signal and a vertical synchronization signal superimposed on the image signal transmitted to the connector 9 from the scope distal end 5 via the optical fiber cable 10, in the embodiment. As shown in the drawing, the horizontal synchronization signal and the vertical synchronization signal are superimposed on the image signal transmitted to the connector 9 from the scope distal end 5 via the optical fiber cable 10. Specifically, before the image signal corresponding to one frame (the digital signal corresponding to 1080 lines) is transmitted, the vertical synchronization signal is transmitted. In addition, before the image signal corresponding to one line (the digital signal corresponding to 1920 pixels) is transmitted, the horizontal synchronization signal is superimposed.

Accordingly, the detection unit 93 is possible to determine that the image signal is transmitted from the scope distal end 5 via the optical fiber cable 10, when the vertical synchronization signal or the horizontal synchronization signal is included in the image signal output by the amplifier 92. That is, the detection unit 93 is possible of determine that the optical transmission line functions normally, when the vertical synchronization signal or the horizontal synchronization signal is included in the image signal output by the amplifier 92. The detection unit 93 outputs CONT “L (=0)” as the detection signal when it is determined that the optical fiber cable 10 functions normally. In addition, the detection unit 93 outputs CONT “H (=1)” as the detection signal when it is determined that the optical fiber cable 10 functions abnormally.

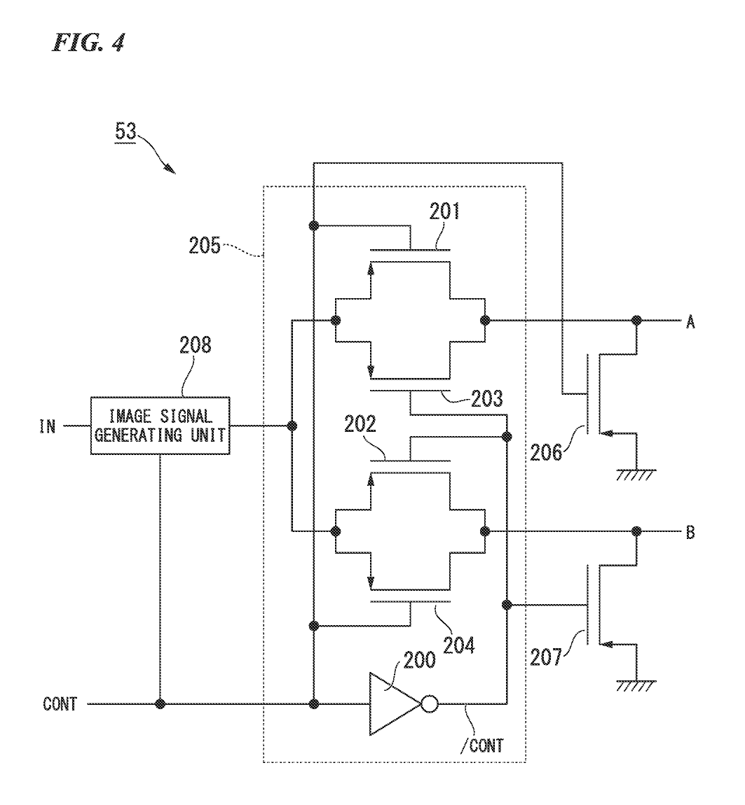

Next, a circuit configuration of the switching unit 53 will be described. FIG. 4 is a circuit diagram showing the circuit configuration of the switching unit 53 in the embodiment. In a shown FIG. 4, the switching unit 53 includes the image signal generating unit 208, a switch circuit 205, and NMOS transistors 206 and 207. In addition, the switch circuit 205 includes an inverter 200, PMOS transistors 201 and 202, and NMOS transistors 203 and 204.

The PMOS transistor 201 and the NMOS transistor 203 form a MOS switch, and the PMOS transistor 202 and the NMOS transistor 204 form a MOS switch. In addition, source terminals of the PMOS transistor 201 and the PMOS transistor 202 are connected. Further, source terminals of the PMOS transistor 202 and the NMOS transistor 204 are connected. The pixel signal IN output by the imaging unit 51 is input into the image signal generating unit 208.

The image signal generating unit 208 generates an image signal using a pixel signal IN based on a detection signal CONT transmitted from the detection unit 93. Specifically, the image signal generating unit 208 generates an image signal without thinning the pixel signal output by the imaging unit 51 when the detection signal CONT is “L (=0).” In addition, the image signal generating unit 208 generates the image signal in which the pixel signal output by the imaging unit 51 is thinned when the detection signal CONT is “H (=1).” The image signal generated by the image signal generating unit 208 will be described below. The source terminals of the PMOS transistor 201, the NMOS transistor 203, the PMOS transistor 202, and the NMOS transistor 204 are commonly connected to the image signal generating unit 208.

The detection signal CONT transmitted from the detection unit 93 is input into the inverter 200, and input into the gate terminals of the PMOS transistor 201 and the NMOS transistor 204. In addition, logic of the detection signal CONT is inverted by the inverter 200. An inversion signal /CONT in which the logic is inverted via the inverter 200 is input into the gate terminals of the NMOS transistor 203 and the PMOS transistor 202. In addition, drain terminals of the PMOS transistor 201 and the NMOS transistor 203 are connected, and the connection becomes a terminal A. Further, drain terminals of the PMOS transistor 202 and the NMOS transistor 204 are connected, and the connection becomes a terminal B.

In the NMOS transistor 206, the source terminal is connected to a GND (ground), the gate terminal is connected to the detection signal CONT, and the drain terminal is connected to the terminal A. In the NMOS transistor 207, the source terminal is connected to the GND (ground), the gate terminal is connected to the inverse signal /CONT of the detection signal CONT, and the drain terminal is connected to the terminal B. Accordingly, when the detection signal CONT is “H (=1),” the image signal is output to the terminal B, and when the detection signal CONT is “L (=0),” the image signal is output to the terminal A.

In addition, when the detection signal CONT is “H (=1),” the terminal A becomes GND, and when the detection signal CONT is “L (=0),” the terminal B becomes GND, by the NMOS transistor 206 and the NMOS transistor 207. Accordingly, as the terminal to which the image signal is not output becomes GND, a floating state can be avoided to stabilize potential.

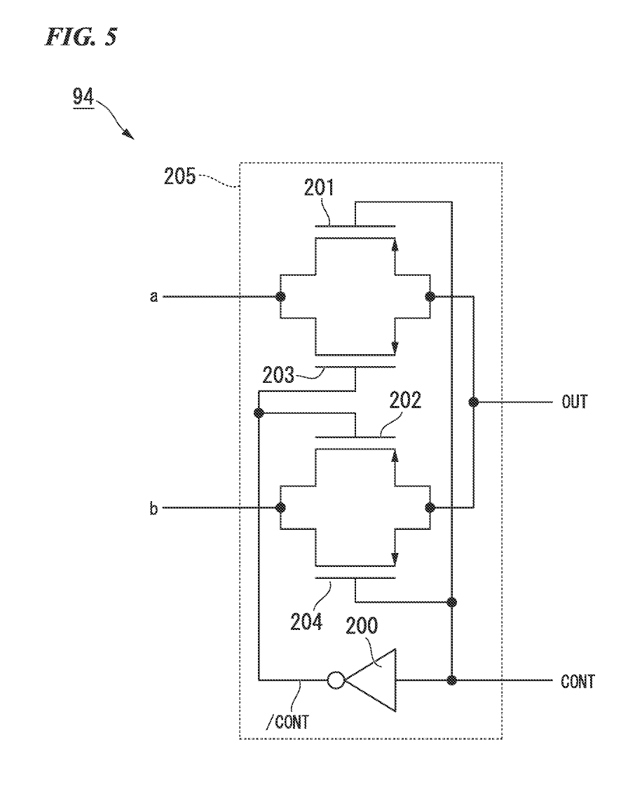

Next, a circuit configuration of the selection unit 94 will be described. FIG. 5 is a circuit diagram showing the circuit configuration of the selection unit 94 in the embodiment. In a shown example, the selection unit 94 includes the switch circuit 205 shown in FIG. 4. The image signal output by the amplifier 92 is input into a terminal a. In addition, the image signal transmitted from the switching unit 53 of the scope distal end 5 via the electric cable 11 is input into a terminal b. Further, the detection signal CONT output by the detection unit 93 is input into the inverter 200. Accordingly, when the detection signal CONT is “H (=1),” the image signal is input into the terminal b is output as OUT, and when the detection signal CONT is “L (=0),” the image signal input into the terminal a is output as OUT.

Next, the image signal generated by the image signal generating unit 208 will be described. In the embodiment, the imaging unit 51 includes an imaging region having a pixel number of full HD (horizontal pixel number 1920×vertical pixel number 1080), a frame rate is assumed to 60 fps, and gradation is assumed to 10 bits. Specifically, the imaging unit 51 outputs 1920 pixel signals in a horizontal direction and 1080 pixel signals in a vertical direction.

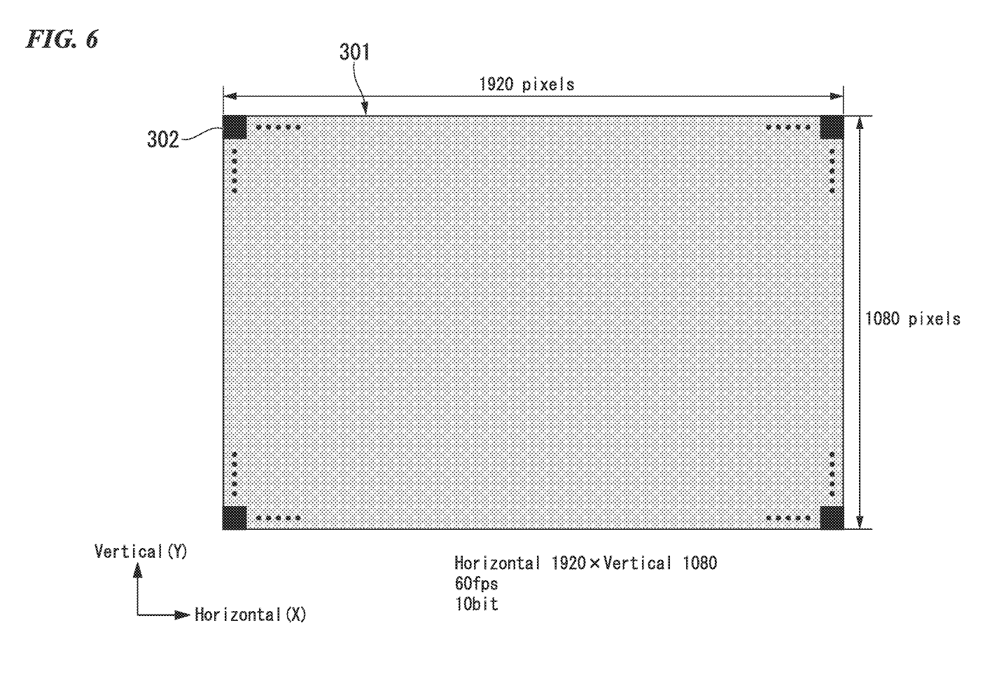

FIG. 6 is a schematic view showing a pixel signal used when the image signal generating unit 208 of the embodiment generates the image signal without thinning the pixel signal output by the pixel included in the imaging unit 51. In the shown example, an imaging region 301 of the imaging unit 51 and a pixel 302 included in the imaging region 301 are shown. In the example, the image signal generating unit 208 generates a image signal in which a pixel number in the horizontal direction is 1920, a pixel number in the vertical direction is 1080 (full HD (horizontal pixel number 1920×vertical pixel number 1080)), a frame rate is 60 fps, and gradation is 10 bits, as the image signal (the first image signal) generated without thinning the pixel signal output by the imaging unit 51. In this case, a transmission rate of the image signal generated by the image signal generating unit 208 is about 1.2 Gbps (1920×1080 pixels×60 fps×10 bits).

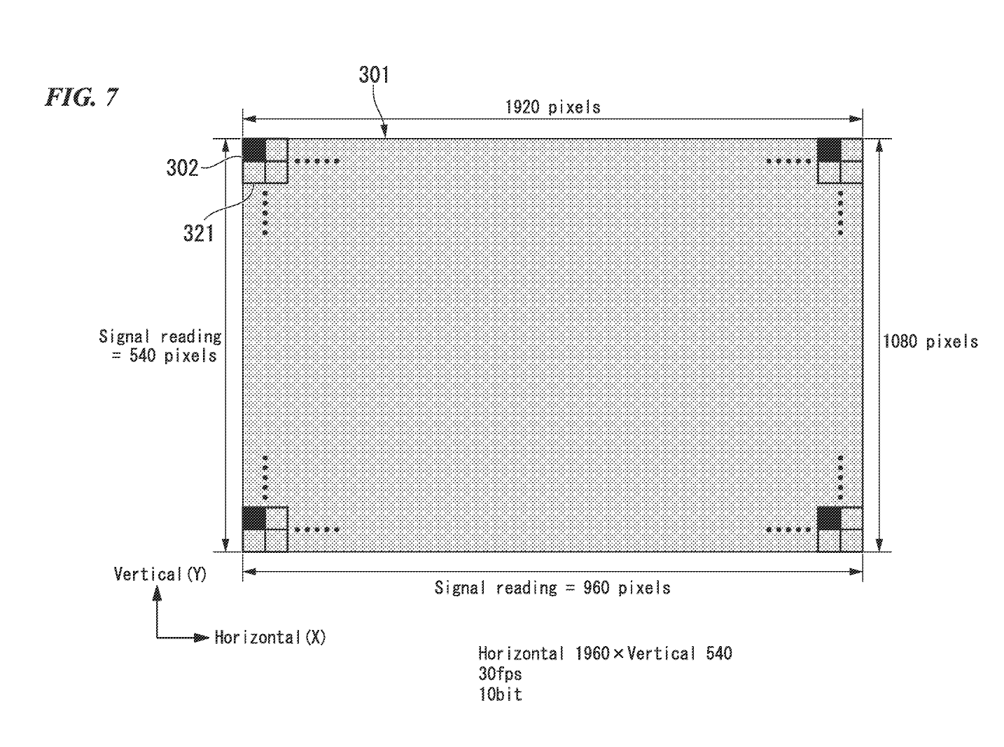

FIG. 7 is a schematic view showing a image signal used when the image signal generating unit 208 of the embodiment generates the image signal in which the pixel signal output by the pixel included in the imaging unit 51 is thinned.

In a shown example, the imaging region 301 of the imaging unit 51 and the pixel 302 included in the imaging region 301 are shown. In the example, the image signal generating unit 208 generates an image signal in which a pixel number in the horizontal direction is 960, a pixel number in the vertical direction is 540, a frame rate is 30 fps, and gradation is 10 bits, as an image signal (a second image signal) generated by thinning the pixel signal output by the imaging unit 51.

Even in the example, the pixel signal of the entire pixel constituting the imaging region 301 is input into the image signal generating unit 208 of the switching unit 53 from the imaging unit 51 at the frame rate=60 fps and the gradation=10 bits. The image signal generating unit 208 divides the imaging region 301 into 960 in the horizontal direction and 540 in the vertical direction using a unit constituted by total four pixels 302 of 2 pixels in the horizontal (X) direction and 2 pixels in the vertical (Y) direction as a basic unit 321. Then, the image signal generating unit 208 reads the pixel signal output by the pixel 302 (the pixel 302 painted with black in the drawing) at an upper left side of the basic unit 321 at the frame rate=30 fps and the gradation=10 bits, and generates the image signal.

The number of pixels included in the image signal of the example becomes ¼ of all of the pixels 302 constituting the imaging region 301, and a thinning rate becomes 75%. The thinning rate when the entire pixel signal is read becomes 0%. In addition, the transmission rate of the image signal in the example becomes about 155 Mbps (960×540 pixels×30 fps×10 bits). As described above, as the number of pixels and the frame rate included in the image signal are reduced, the image signal can be transmitted using one electrical transmission line. While detailed description of a configuration of the image signal generating unit 208 is omitted, the handled signal is a digital signal. For this reason, in the conventional technique such as a signal holding unit such as a frame memory, and a selector, or the like, the image signal in which the pixel signal output by the pixel 302 included in the imaging unit 51 is thinned is possible to be generated.

Next, an operation of the endoscope system 1 will be described. Conventionally, in order to observe an image having high image quality, the endoscope system 1 transmits the image signal from the scope distal end 5 to the connector 9 using the optical fiber cable 10. When the optical transmission line functions normally, the detection unit 93 detects that the optical transmission line functions normally, and outputs that the detection signal CONT is “L (=0).” Accordingly, as shown in FIG. 6, the image signal generating unit 208 of the switching unit 53 generates the image signal without thinning the pixel signal output by all of the pixels 302 constituting the imaging region 301 of the imaging unit 51.

In addition, as described above, when the detection signal CONT is “L (=0),” the switching unit 53 outputs the image signal from the terminal A. The image signal output by the switching unit 53 is optically transmitted by the driver 54, the E/O converter unit 55, the optical fiber cable 10, the O/E converter unit 91, and the amplifier 92 to be transmit to the selection unit 94. Further, as described above, when the detection signal CONT is “L (=0),” the selection unit 94 outputs the image signal input into the terminal a to the image signal processing unit 31. The image signal processing unit 31 performs the image processing of the image transmission signal input from the selection unit 94, and displays the image on the monitor 4. Accordingly, when the optical transmission line functions normally, the endo scope system 1 can transmit the image signal having high image quality from the scope distal end 5 to the endoscope main body 3 using the optical fiber cable 10. In addition, when the optical transmission line functions normally, the endoscope system 1 is possible to display the image having high image quality on the monitor 4.

Here, when the optical transmission line functions abnormally, for example, when the optical fiber cable 10 is disconnected, or the like, the detection unit 93 detects that the optical transmission line functions abnormally, and outputs that the detection signal CONT is “H (=1).” Accordingly, as shown in FIG. 7, the image signal generating unit 208 of the switching unit 53 generates the image signal in which the pixel signal output by the pixel 302 constituting the imaging region 301 of the imaging unit 51 is thinned.

In addition, as described above, when the detection signal CONT is “H (=1),” the switching unit 53 outputs the image signal from the terminal B. The image signal output by the switching unit 53 is transmitted through the electric cable 11 and transmitted to the selection unit 94. In addition, as described above, when the detection signal CONT is “H (=1),” the selection unit 94 outputs the image signal input into the terminal b to the image signal processing unit 31. The image signal processing unit 31 performs the image processing of the image transmission signal input from the selection unit 94, and displays the image on the monitor 4. Accordingly, even when the optical transmission line functions abnormally, the endoscope system 1 can transmit the image signal, in which the pixel signal output by the pixel constituting the imaging region of the imaging unit 51 is thinned, from the scope distal end 5 to the endoscope main body 3 using the electric cable 11.

As described above, according to the embodiment, when the optical transmission line functions abnormally, for example, when the optical fiber cable 10 is disconnected, or the like, the image signal in which the pixel signal output by the pixel 302 constituting the imaging region 301 of the imaging unit 51 is thinned is transmitted to the endoscope main body 3 from the scope distal end 5 using the electric cable 11, which is the electrical transmission line. Accordingly, even when the optical transmission line is abnormally operated, the image signal transmitted to the endoscope main body 3 from the scope distal end 5 can be prevented from being interrupted.

In the embodiment, while the case in which the selection unit 94 is disposed at the connector 9 has been described, the selection unit 94 may be disposed at the manipulation unit 7 or the endoscope main body 3. In addition, in the embodiment, while the case in which the image signal generated by the image signal generating unit 208 is transmitted through any one selected from the optical transmission line and the electrical transmission line has been described, the circuit configuration of the switching unit 53 may be appropriately varied to transmit the image signal to both of the optical transmission line and the electrical transmission line. In this case, the selection unit 94 may select any one of the image signals.

### Second Embodiment

Next, a second embodiment of the present invention will be described. In the embodiment, an image signal transmitted through the electrical transmission line is different from that of the first embodiment. In the embodiment, when the image signal is transmitted through the electrical transmission line, an image more appropriate for an actual use situation is displayed on the monitor by applying different image modes upon observation of the inside of an object to be inspected and upon treatment with a forceps or the like. Common elements with the above-mentioned first embodiment are designated by the same reference numerals, and description thereof will be omitted.

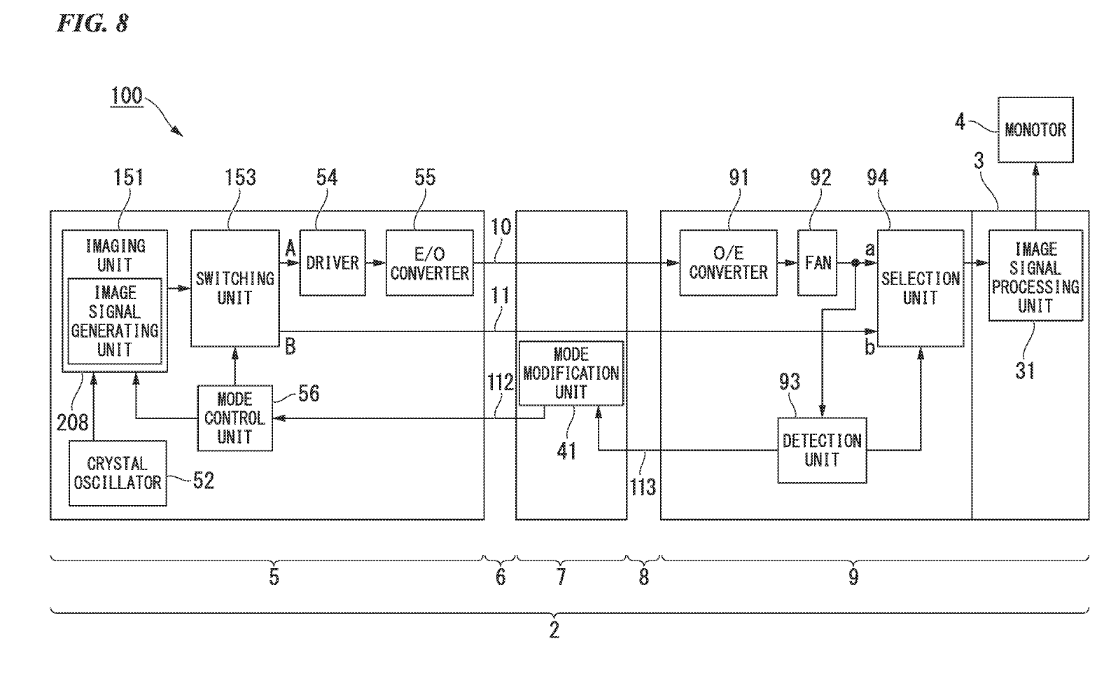

FIG. 8 is a block diagram showing a configuration of an endoscope system 100 of the embodiment. In FIG. 8, in the embodiment, only a part needed to describe image signal transmission is shown. The endoscope system 100 shown in FIG. 8 is distinguished from the endoscope system 1 of the first embodiment shown in FIG. 2 in that the scope distal end 5 includes a mode control unit 56, the manipulation unit 7 includes a mode change unit 41, and an imaging unit 151 instead of a switching unit 153 includes the image signal generating unit 208.

In a shown example, the scope distal end 5 includes the imaging unit 151, a crystal oscillator 52, the switching unit 153, a driver 54, an E/O converter 55, and a mode control unit 56. In addition, the manipulation unit 7 includes a mode change unit 41. Further, the connector 9 includes an O/E converter 91, an amplifier 92, a detection unit 93, and a selection unit 94. The endoscope main body 3 includes an image signal processing unit 31.

In addition, the insertion unit 6 and the manipulation unit 7 include the optical fiber cable 10, and the electric cables 11 and 112. Further, the manipulation unit 7 and the universal cord 8 include the optical fiber cable 10, and the electric cables 11 and 113. The optical fiber cable 10 is connected to the E/O converter unit 55 of the scope distal end 5 and the DIE converter 91 of the connector 9. In addition, the electric cable 11 is connected to the switching unit 153 of the scope distal end 5 and the selection unit 94 of the connector 9. Further, the electric cable 112 is connected to the mode control unit 56 of the scope distal end 5 and the mode change unit 41 of the manipulation unit 7. In addition, the electric cable 113 is connected to the mode change unit 41 of the manipulation unit 7 and the detection unit 93 of the connector 9.

The crystal oscillator 52, the driver 54, the E/O converter 55, the mode control unit 56, the O/E converter 91, the amplifier 92, the detection unit 93, the selection unit 94, the image signal processing unit 31, the optical fiber cable 10, and the electric cable 11 are the same as the elements of the first embodiment.

The mode control unit 56 controls the switching unit 153 and the imaging unit 151 based on an image mode signal transmitted from the mode change unit 41. The mode control unit 56 will be described below in detail.

The mode change unit 41 receives a detection signal received from the detection unit 93 via the electric cable 113. In addition, the mode change unit 41 receives an input of instructing either of image modes using a manual switch (not shown) or the like. In the embodiment, the image modes have a “first mode” representing an observation mode and a “second mode” representing a forceps mode. The “first mode” representing the observation mode is an image mode used when observation of a wide area in the object to be inspected is performed. The “second mode” representing the forceps mode is an image mode used when treatment with the forceps or the like is performed. In addition, the mode change unit 41 transmits the image mode signal representing the image mode in which an input has been received and the detection signal transmitted from the detection unit 93 to the mode control unit 56 via the electric cable 112.

The imaging unit 151 includes, for example, a CMOS sensor. The CMOS sensor includes an imaging region constituted by a plurality of pixels. In addition, the imaging unit 151 includes a drive circuit configured to read signals from the plurality of pixels, a resistor configured to control an operation of the drive circuit, and an image signal generating unit 208. The image signal generating unit 208 sets the resistor to control the operation of the drive circuit, and performs selection of the pixel reading the pixel signal, or setting of a frame rate or gradation, based on the image mode signal input from the mode control unit 56.

The switching unit 153 acquires an image signal output by the imaging unit 151. In addition, the switching unit 153 outputs the acquired image signal to the driver 54, or outputs the image signal to the selection unit 94 of the connector 9 via the electric cable 11, based on the detection signal input from the mode control unit 56. A terminal output to the driver 54 is designated to an output terminal A, and a terminal output to the selection unit 94 of the connector 9 via the electric cable 11 is designated to an output terminal B. A circuit configuration of the switching unit 153 is different from the circuit diagram shown in FIG. 4. The switching unit 153 includes merely a switch circuit 205 configured to select an image signal, and NMOS transistors 206 and 207 configured to designate the terminal, from which no image signal is output, as GND, and avoid a floating state to stabilize potential. However, the switching unit 153 does not include the image signal generating unit 208. The switching unit 153 outputs the image signal input from the imaging unit 151 as it is.

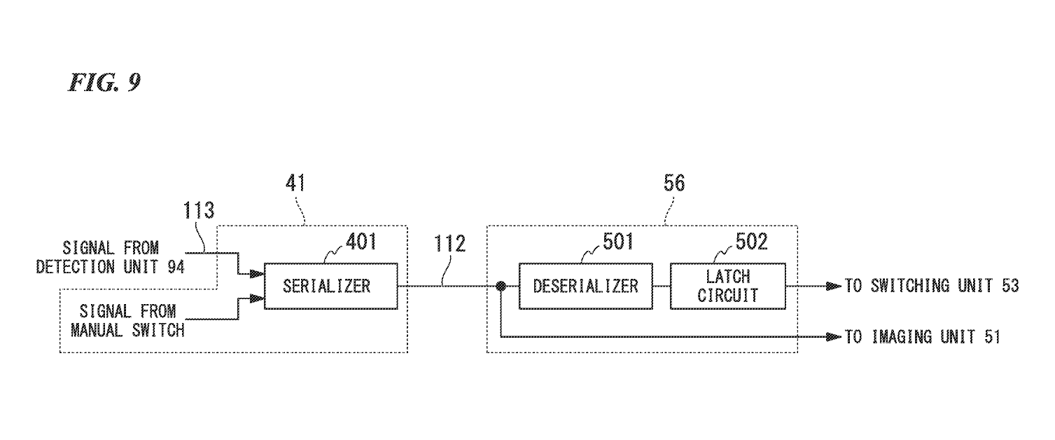

Next, a circuit configuration of the mode change unit 41 and the mode control unit 56 will be described. FIG. 9 is a block diagram showing the circuit configuration of the mode change unit 41 and the mode control unit 56 of the embodiment. In a shown example, the mode change unit 41 includes a serializer 401. In addition, the mode control unit 56 includes a deserializer 501 and a latch circuit 502. A detection signal transmitted from the detection unit 93 via the electric cable 113 and an image mode signal received by a manual switch included in the mode change unit 41 are input into the mode change unit 41. The serializer 401 serializes two signals of different systems of the detection signal and the image mode signal input into the mode change unit 41.

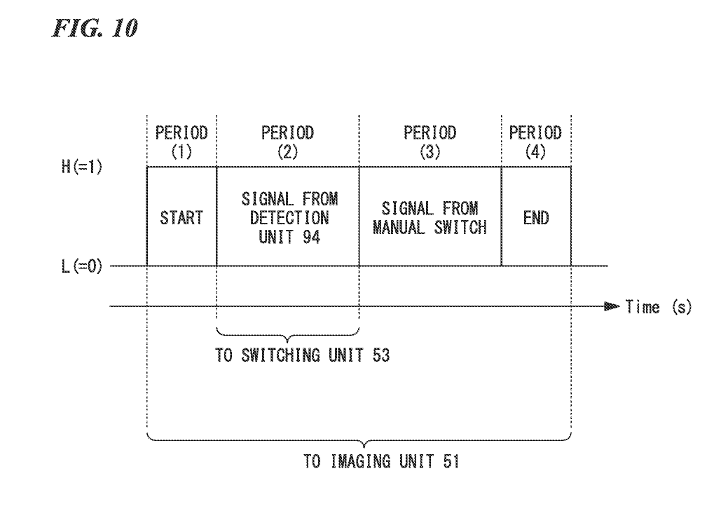

FIG. 10 is a schematic view schematically showing a serial signal serialized by the serializer 401. The serial signal is constituted by a START period (1) representing start of the serial signal, a period (2) including a detection signal input from the detection unit 93, a period (3) including an image mode signal received by the manual switch, and an END period (4) representing completion of the serial signal, and is transmitted to the mode control unit 56 in time series.

Hereinafter, the description will return to FIG. 9. The serial signal transmitted from the mode change unit 41 via the electric cable 112 is input into the mode control unit 56. The deserializer 501 extracts only the detection signal included in the period (2) from the serial signal input into the mode control unit 56. The latch circuit 502 latches the detection signal extracted by the deserializer 501 and inputs the latched detection signal to the switching unit 153. In addition, the mode control unit 56 inputs the serial signal transmitted from the mode change unit 41 via the electric cable 112 to the imaging unit 51 as it is.

The mode change unit 41 may transmit the serial signal to the mode control unit 56 only when the manual switch of the mode change unit 41 is received an input and when the detection signal input from the detection unit 93 is varied. In this case, the mode control unit 56 is operated based on the most recently input serial signal, until a new serial signal is input. Accordingly, change of the image mode can be easily performed. The image signal generating unit 208 of the imaging unit 51 performs setting of the resistor or control of the operation of the drive circuit, and generates the image signal, based on the detection signal and the image mode signal included in the serial signal.

Next, the image signal generated by the image signal generating unit 208 will be described. In the embodiment, the CMOS sensor included in the imaging unit 51 includes an imaging region having full HD resolution (horizontal resolution 1920 pixels×vertical resolution 1080 pixels). When the detection signal input from the mode control unit 56 is “L (=0),” the image signal generating unit 208 reads the pixel signal from all of the pixels included in the CMOS sensor at a frame rate of 60 fps and gradation of 10 bits. In addition, the image signal generating unit 208 generates an image signal (a first image signal) using the read pixel signal. That is, the image signal generating unit 208 generates an image signal as shown in FIG. 6 in the first embodiment.

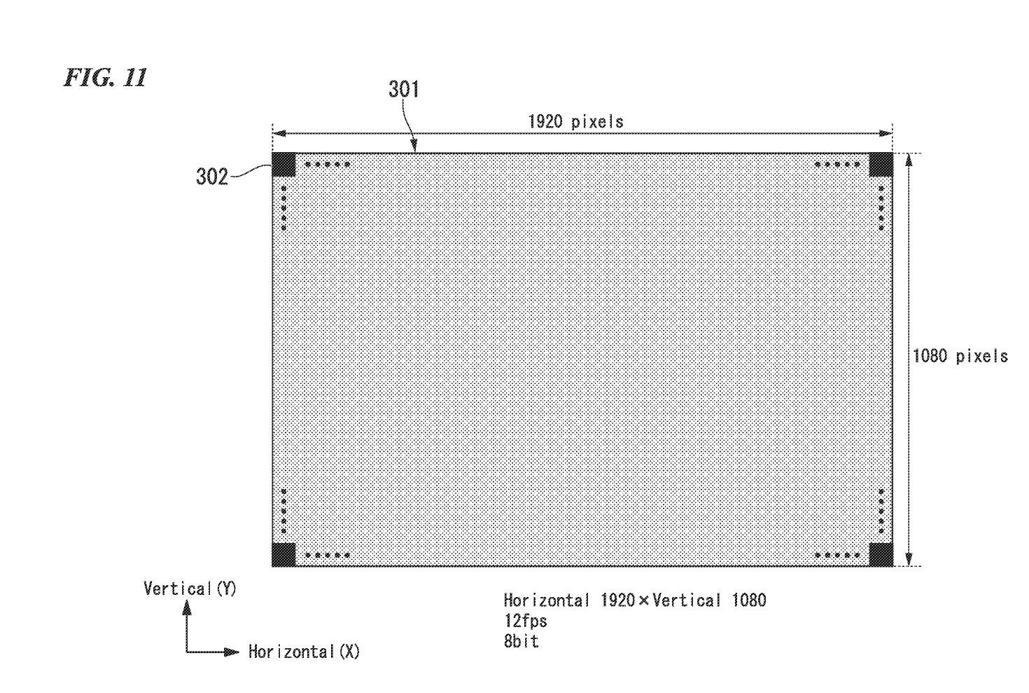

Next, an image signal (a second image signal) generated by the image signal generating unit 208 when the detection signal input from the mode control unit 56 is “H (=1)” and the image mode signal input from the mode control unit 56 is a “first mode” representing an observation mode will be described. FIG. 11 is a schematic view showing a pixel signal used upon generation of the image signal by the image signal generating unit 208 of the embodiment when the input detection signal is “H (=1)” and the input image mode signal is the “first mode.”

In a shown example, the imaging region 301 of the imaging unit 51, and the pixel 302 included in the imaging region 301 are shown. In the example, the image signal generating unit 208 reads the pixel signal from all of the pixels 302 included in the CMOS sensor at a frame rate of 12 fps and gradation of 8 bits. In addition, the image signal generating unit 208 generates the image signal using the read pixel signal. A horizontal resolution of the image signal is 1920 pixels, a vertical resolution is 1080 pixels, a frame rate is 12 fps, and gradation is 8 bits. Accordingly, a transmission rate of the image signal is about 199 Mbps (1920×1080 pixels×12 fps×8 bits). Accordingly, the endoscope system 100 is possible to transmit the image signal from the scope distal end 5 to the endoscope main body 3 using one electric cable 11.

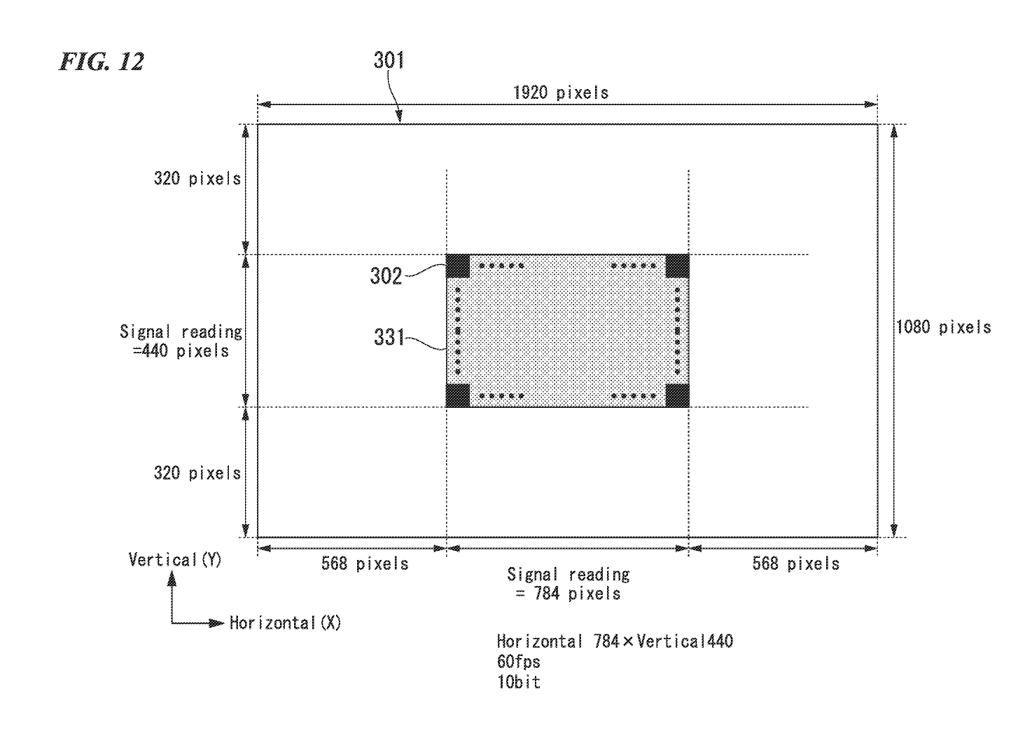

Next, an image signal (a second image signal) generated by the image signal generating unit 208 when the detection signal input from the mode control unit 56 is “H (=1)” and the image mode signal input from the mode control unit 56 is a “second mode” representing a forceps mode will be described. FIG. 12 is a schematic view showing the pixel signal used upon generation of the image signal by the image signal generating unit 208 of the embodiment when the input detection signal is “H (=1)” and the input image mode signal is the “second mode.”

In a shown example, the imaging region 301 of the imaging unit 51, a region 331 of a substantially central area of the imaging region 301, and the pixel 302 included in the region 331 of the substantially central area of the imaging region 301 are shown. In the example, the image signal generating unit 208 reads the pixel signal from the pixel 302 (784×440 pixels) included in the region 331 of the substantially central area of the imaging region 301, among the pixels 302 included in the imaging region 301 of the CMOS sensor, at a frame rate of 60 fps and gradation of 10 bits. The image signal generating unit 208 generates the image signal using the read pixel signal. A horizontal resolution of the image signal is 784 pixels, a vertical resolution is 440 pixels, a frame rate is 60 fps and gradation is 10 bits. Accordingly, the transmission rate of the image signal is about 200 Mbps (784×440 pixels×60 fps×10 bits). Accordingly, the endoscope system 100 can transmit the image signal from the scope distal end 5 to the endoscope main body 3 using one electric cable 11.

Next, an operation of the endoscope system 100 will be described. Conventionally, in order to observe the image having high image quality, the endoscope system 1 transmits the image signal from the scope distal end 5 to the connector 9 using the optical fiber cable 10. When the optical transmission line functions normally, the detection unit 93 detects that the optical transmission line functions normally and outputs that the detection signal CONT is “L (=0)” to the mode change unit 41. The mode change unit 41 inputs the input detection signal CONT “L (=0)” to the mode control unit 56. The mode control unit 56 inputs the detection signal CONT “L (=0)” to the imaging unit 151 and the switching unit 153. Accordingly, the image signal generating unit 208 of the imaging unit 151 reads the pixel signal from all of the pixels of the CMOS sensor at a frame rate of 60 fps and gradation of 10 bits, and generates the image signal based on the read pixel signal.

In addition, as described above, when the detection signal CONT is “L (=0),” the switching unit 53 outputs the image signal from the terminal A. The image signal output by the switching unit 53 is optically transmitted by the driver 54, the E/O converter 55, the optical fiber cable 10, the O/E converter 91, and the amplifier 92, and transmitted to the selection unit 94. Further, as described above, when the detection signal CONT is “L (=0),” the selection unit 94 outputs the image signal input into the terminal a to the image signal processing unit 31. The image signal processing unit 31 performs the image processing of the image transmission signal input from the selection unit 94, and displays the image on the monitor 4. Accordingly, when the optical transmission line functions normally, the endoscope system 1 can transmit the image signal having high quality from the scope distal end 5 to the endoscope main body 3 using the optical fiber cable 10. In addition, when the optical transmission line functions normally, the endoscope system 1 is possible to display the image having high quality on the monitor 4.

Here, when the optical transmission line functions abnormally, for example, when the optical fiber cable 10 is disconnected, or the like, the detection unit 93 detects that the optical transmission line functions abnormally, and outputs the detection signal CONT “H (=1).” The detection signal output by the detection unit 93 is input into the mode change unit 41. The mode change unit 41 inputs the image mode signal representing the image mode selected by a manual switch and the input detection signal CONT “H (=1)” to the mode control unit 56. The mode control unit 56 inputs the detection signal CONT “H (=1)” and the image mode signal into the imaging unit 151, and inputs the detection signal CONT “H (=1)” into the switching unit 153.

Accordingly, the image signal generating unit 208 of the imaging unit 151 generates the image signal based on the image mode signal. Specifically, when the input detection signal is “H (=1)” and the input image mode signal is the “first mode” representing the observation mode, the image signal generating unit 208 generates the image signal as shown in FIG. 11. In addition, when the input detection signal is “H (=1)” and the input image mode signal is the “second mode” representing the forceps mode, the image signal generating unit 208 generates the image signal as shown in FIG. 12.

In addition, as described above, when the detection signal CONT is “H (=1),” the switching unit 53 outputs the image signal from the terminal B. The image signal output by the switching unit 53 is transmitted by the electric cable 11 and transmitted to the selection unit 94. In addition, as described above, when the detection signal CONT is “H (=1),” the selection unit 94 outputs the image signal input into the terminal b to the image signal processing unit 31. The image signal processing unit 31 performs the image processing of the image transmission signal input from the selection unit 94, and displays the image on the monitor 4. Accordingly, even when the optical transmission line functions abnormally, the endoscope system 1 can transmit the image signal according to the image mode from the scope distal end 5 to the endoscope main body 3 using the electric cable 11.

As described above, according to the embodiment, when the optical transmission line functions abnormally, for example, when the optical fiber cable 10 is disconnected, the image signal according to the image mode is generated, and the generated image signal is transmitted from the scope distal end 5 to the endoscope main body 3 using the electric cable 11, which is the electrical transmission line. For example, even when the optical transmission line functions abnormally, the image mode is set to the first mode when the inside of the object to be inspected is observed. Accordingly, the image signal is generated using the pixel signal output by all of the pixels 302 constituting the imaging region 301 of the CMOS and transmitted via the electric cable 11. Accordingly, spatial resolution (the number of pixels) of the image signal of one frame becomes similar to the case of the transmission through the optical transmission line, and a wide area in the object to be inspected is possible to be observed.

In addition, for example, even when the optical transmission line functions abnormally, as the image mode is set to the second mode upon treatment of the forceps or the like, a viewing field of the image signal of one frame becomes the region 331 of the substantially central area of the imaging region 301 of the CMOS to be narrowed. However, the frame rate and the gradation generate the same image signal as in the case of the transmission through the optical transmission line, which is transmitted via the electric cable 11.

Accordingly, since the frame rate and the gradation are the same as in the case of the transmission through the optical transmission line and the image following movement of the forceps or the like is displayed on the monitor 4, treatment with the forceps or the like can be easily performed.

As described above, in the embodiment, even when the optical transmission line functions abnormally, for example, when the optical fiber cable 10 is disconnected, or the like, the endoscope system that transmits the image signal more appropriate for an actual use situation is possible to be realized. Here, when the optical transmission line functions abnormally, the example in which the image signals of two different image modes of the first mode and the second mode are generated and transmitted has been described, but the present invention is not limited thereto, and the image signals of three or more image modes may be generated and transmitted. In addition, in the above-mentioned example, when the image mode is the second mode, while the case in which the image signal of the region 331 of the substantially central area of the imaging region 301 of the CMOS is formed has been described, but the present invention is not limited thereto, and the image signal of an arbitrary region of the imaging region 301 may be generated. In addition, while the case in which the mode change unit 41 is disposed at the manipulation unit 7 has been described, but the present invention is not limited thereto, and the mode change unit 41 may be disposed at the endoscope main body 3, or may be disposed at both of the manipulation unit 7 and the endoscope main body 3.

### Third Embodiment

Next, a third embodiment of the present invention will be described. A configuration of the endoscope system 1 of the embodiment is the same as of the endoscope system 1 of the first embodiment. The embodiment is distinguished from the first embodiment in that the image signal is generated by the image signal generating unit 208 when the detection signal is “H (=1).”

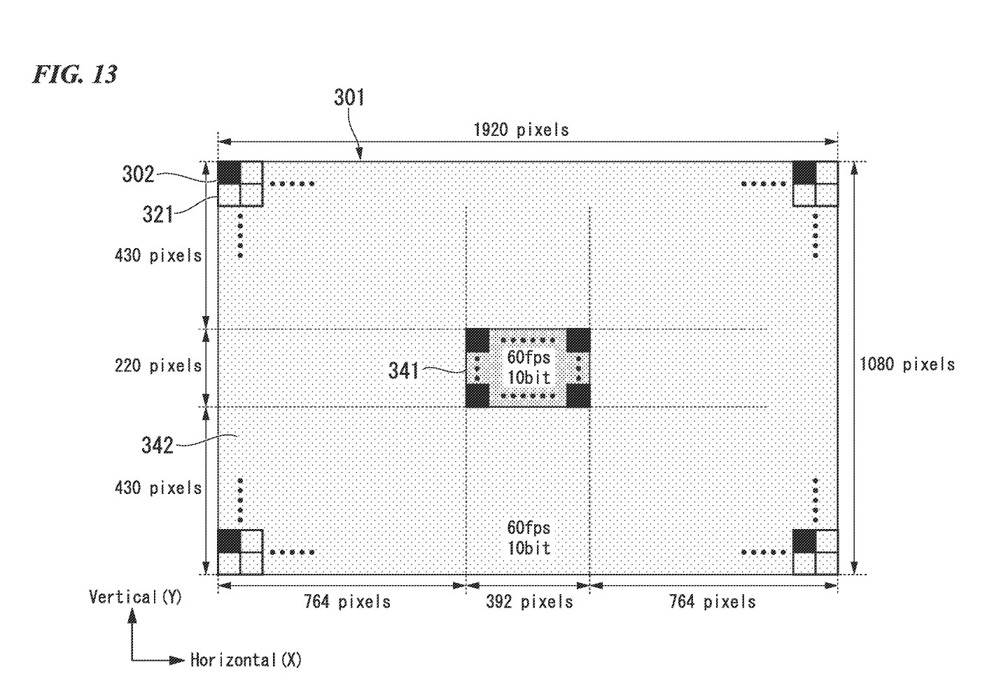

FIG. 13 is a schematic view showing the pixel signal used upon generation of an image signal (a second image signal) by the image signal generating unit 208 of the embodiment when the input detection signal is “H (=1).” In a shown example, the imaging region 301 of the imaging unit 51, the pixels 302 included in the imaging region 301, a region 341 of the substantially central area of the imaging region 301, and a region 342 of the imaging region 301 other than the region 341 of the substantially central area are shown.

In the example, the image signal generating unit 208 generates the image signal by thinning the pixel signal output by the pixels 302 included in the region 342 other than the region 341 of the substantially central area, without thinning the pixel signal output by the pixels 302 (392×220 pixels) included in the region 341 of the substantially central area of the imaging region 301 of the CMOS sensor. The frame rate and gradation of the image signal generating using the pixel signal output by the pixel 302s (392×220 pixels) included in the region 341 of the substantially central area are 60 fps and 10 bits, which are the same as in the transmission through the optical transmission line. Accordingly, the transmission rate of the image signal of the region 341 of the substantially central area is about 50 Mbps (392×220 pixels×60 fps×10 bits).

In addition, in the region 342 other than the region 341 of the substantially central area, the image signal generating unit 208 sets a unit constituted by a total of four pixels 302 of 2 pixels in a horizontal (X) direction and 2 pixels in a vertical (Y) direction as a basic unit 321, and divides the region 342 other than the region 341 of the substantially central area into 960 in the horizontal direction and 540 in the vertical direction. Then, the image signal generating unit 208 reads the pixel signal output by the pixel 302 (the pixel 302 painted with black in the drawing) of a left upper side in each basic unit 321 at a frame rate=30 fps and gradation=10 bits, and generates the image signal. Accordingly, the transmission rate of the image signal of the region 342 other than the region 341 of the substantially central area is about 150 Mbps ((960×540)−(392/2×220/2) pixels×30 fps×10 bits).

Accordingly, a transmission rate of a total image signal obtained by summation of the image signal of the region 341 of the substantially central area and the image signal of the region 342 other than the region 341 of the substantially central area is about 200 Mbps (50 Mbps+150 Mbps). As described above, even when a thinning rate is varied at each region, the image signal can be transmitted using the electrical transmission line.

As described above, according to the embodiment, even when the optical transmission line functions abnormally, for example, when the optical fiber cable 10 is disconnected, or the like, the image signal as shown in FIG. 13 is generated. Accordingly, the image signal in which the imaging region is widened and the image quality of the central area becomes high image quality can be transmitted from the scope distal end 5 to the endoscope main body 3 using one electric cable 11. Accordingly, even when the optical transmission line functions abnormally, since the inside of the object to be inspected can be observed at a view angle (a viewing field range) of the imaging region and the image quality of the substantially central area of the imaging region is high image quality, treatment with the forceps or the like becomes easy.

In addition, in the embodiment, while the case in which the imaging region of the CMOS sensor included in the imaging unit 51 is divided into two regions has been described, the number of divided regions, the number of pixels constituting each region, the frame rate and the gradation are not limited to the above-mentioned example. For example, according to the transmission rate transmittable through one electric cable, the number of divided regions, the number of pixels constituting the region, the frame rate and the gradation may be variously assembled.

Hereinabove, while the embodiments of the present invention have been described with reference to the accompanying drawings, a specific configuration is not limited to the embodiments, and includes design changes without departing from the spirit of the present invention. For example, the above-mentioned first to third embodiments are embodiments in consideration of using the electrical transmission line as a backup when the optical transmission line functions abnormally. For this reason, since the external size of the endoscope scope 2 is suppressed to a minimal level, the case in which the electrical transmission line is provided as one electric cable has been described, but it is not limited thereto. For example, the number of electric cables is not limited, and two or more electric cables may be provided according to external dimensions of the endoscope scope 2 determined by a use (the object to be inspected). In addition, the data volume of the image signal may be reduced and transmitted through the scope distal end 5 using a conventional data compression technique, or the like. Hereinabove, while the exemplary embodiments of the present invention have been described, the present invention is not limited to the embodiments. Addition, omission, substitution, and other modifications of the elements can be varied without departing from the spirit of the present invention. The present invention is not limited to the above-mentioned description, but limited only by the accompanying claims.

What is claimed is:

1. An endoscope system comprising:
an insertion unit includes a distal end, an optical transmission line configured to transmit a first image signal output by an image signal generating unit as an optical signal and an electrical transmission line configured to transmit a second image signal output by the image signal generating unit as an electrical signal; and
an image signal processing unit configured to perform image processing of any one of the first image signal and the second image signal transmitted by the insertion unit,
wherein the distal end of the insertion unit includes an imaging unit having a plurality of pixels, configured to output a pixel signal, and the image signal generating unit configured to generate the first image signal and the second image signal having a data volume smaller than that of the first image signal by using the pixel signal output by the imaging unit.

2. The endoscope system according to claim 1, wherein at least one of temporal resolution, spatial resolution, and gradation resolution of the second image signal is lower than that of the first image signal.

3. The endoscope system according to claim 2, wherein the image signal generating unit generates the second image signal having spatial resolution lower than that of the first image signal using a portion of the pixel signal, among the pixel signals.

4. The endoscope system according to claim 2, wherein the image signal generating unit generates the first image signal using the pixel signal output by the pixel included in a first region that is an imaging region of the imaging unit, and generates the second image signal using the pixel signal output by the pixel included in a second region that is a region of a portion of the first region.

5. The endoscope system according to claim 2, wherein the image signal generating unit generates the second image signal having temporal resolution lower than that of the first image signal by reducing a frame rate of the second image signal to be lower than that of the first image signal.

6. The endoscope system according to claim 1, wherein the image signal generating unit generates the first image signal or the second image signal.

7. The endoscope system according to claim 1, further comprising a detection unit configured to detect whether the optical transmission line functions normally or not, and configured to control to generate the second image signal to the image signal generating unit when the optical transmission line functions abnormally.

8. The endoscope system according to claim 1, wherein the distal end further comprises a mode control unit configured to control to drive the imaging unit, and
the mode control unit changes a driving method of the imaging unit when the image signal generating unit generates the first image signal and when the image signal generating unit generates the second image signal.
